(19) United States
(12) Patent Application Publication
(10) Pub. No.: US 2016/0047737 A1
(43) Pub. Date: Feb. 18, 2016

(54) CAPVETTE AND METHOD OF MEASURING OPTICAL DENSITY

(71) Applicant: GYANU LAMICHHANE, Towson, MD (US)

(72) Inventor: GYANU LAMICHHANE, Towson, MD (US)

(21) Appl. No.: 14/461,392

(22) Filed: Aug. 16, 2014

(51) Int. Cl. G01N 21/05; G01N 21/31

(52) U.S. Cl. CPC G01N 21/05; G01N 21/31; G01N 2021/0378

(57) ABSTRACT

A capvette for the optical examination of liquids comprises a cuvette component having a rectangular or square basal surface with four side walls terminating into an aperture, wherein said aperture is in communication with a sealable cap component comprising an opening for fluid passageway from a container into said cuvette component. The capvette and container combination, as a single unit allows reaction of fluid or growth of microorganism and measurement of optical density at desired time intervals. A direct method of measuring optical density comprises simply inserting the cuvette component of the capvette into a spectrophotometer.

### BACKGROUND OF THE INVENTION

1. Field of the Invention

The present invention relates generally to optical cuvettes for measuring optical density of liquid samples, and more particularly to a capvette comprising a cuvette component in communication with a cap component having an aperture for fitting onto a container thereby allowing passage of fluid samples into the cuvette component for taking optical density measurements using a spectrophotometer.

2. Description of the Related Art

At present, the commonly used method to measure optical density of a liquid or suspension is to transfer a specimen of the liquid into a cuvette and read the absorbance using a spectrophotometer. In addition, at present, growth of microorganism(s) in a liquid culture or chemical reactions in a liquid mixture are undertaken with a set of devices that are separate and detached from devices used to monitor growth of microorganism or progress of reaction. For the prior, a sealed container is used. Each time the optical density is to be measured, a separate set of devices that are detached from the container in which microorganisms are growing or a reaction in taking place are used. These devices include a pipette to transfer specimen of culture or reaction sample, a cuvette to hold the specimen, and waste disposal material to discard the pipette and cuvette each time an optical density measurement is taken. For example, when an organism is grown in liquid culture in a laboratory, its number and the density changes over time. The most common approach to monitoring the growth of organisms is to measure the optical density of the culture at multiple time intervals. To take a measurement, the cuvette containing the specimen is inserted into a spectrophotometer and the optical density is measured. The specimen liquid or culture and the cuvette are then discarded. This process is repeated a number of times to generate a growth profile of the microbe in the culture. During this iterative process valuable sample, transfer pipets, culture and cuvettes are used and discarded.

Several approaches have been taken to design cuvettes for measuring liquid specimen or measuring optical density of biological samples and cultures. For example, U.S. Pat. No 3,759,374 to Helger et al., discloses disposable cuvettes with square apertures which serve both as a container for reagents used in analytical determinations and for conducting photometric determinations therein. The apertures are sealed by bonding a film or foil to the upper edges of the cuvettes which define their aperture and thereafter separating the sealed cuvettes thus joined together by severing the film or foil along lines defined by their side walls. U.S. Pat. No. 5,430,542 to Sheperd discloses disposable cuvettes with very short optical path length in making spectrophotometric measurements in turbid media such as whole blood.

U.S. Pat. No. 4,083,638 to Sandrock et al. discloses a multichamber cuvette for maintaining in independent and separate condition at least two reactants until such time that it is desired to mix them for reaction with each other and a reactant liquid sample while in the cuvette for analysis especially by optical density in an automated manner of a constituent of body fluids such as blood or urine.

U.S. Pat. No. 4,251,159 to White discloses a cuvette that takes the form of a plurality of optically-clear (i.e., non-frosted) cups, such cups each having side, bottom, and end walls and being arranged in a longitudinal series with the end walls of successive cups disposed in spaced-apart relation.

However, the prior art cuvettes do not provide for rapid optical probing, sampling and monitoring of biological liquid samples such as for example of a microbe culture without opening the container such as a flask or test tube containing the culture and transferring the sample to a cuvette. In the current state of art the cap and the device used specifically for holding a specimen of the liquid for taking optical density measurements are typically two separate pieces or devices. Therefore, it would be desirable to provide an optical cuvette component sealably connected to a cap with an aperture in communication with the cuvette component such that it can be rapidly fitted on a container such as a culture flask, tube or bottle thereby enabling facile measurement of optical density of fluid or microbe culture without having to transfer a specimen to a detached cuvette with the ensuing loss of sample. In addition, a single device that seals a culture/reaction container throughout the experiment and at the same time allows user to repeatedly take optical density measurements without the need for additional devices simplifies the method and eliminates need for cuvettes, pipettes, specimen and waste disposal materials (that are needed when existing art is used) is also desirable. This single device would allow growth of culture, reaction and also measurement of optical density at rapid time scales.

Thus, a cuvette in communication with a sealable cap solving the aforementioned problems is desired.

### SUMMARY OF THE INVENTION

The invention encompasses a capvette and a method of measuring optical density using the capvette. The capvette comprises a cuvette component haying a rectangular or square basal surface with four side walls terminating into an aperture, wherein said aperture is in communication with a sealable cap component comprising an opening for fluid passageway from a container into said cuvette component. The capvette fits vertically above the container in which chemical reaction or microbial culture is grown. The method of measuring optical density of a specimen comprises a) inserting the cuvette component of the capvette on to a container containing a specimen whose optical density is to be determined at desired time intervals by fitting said capvette on an opening of said container; b) inverting said container thereby allowing liquid to flow into the cuvette portion through said hole in the cap component; and c) inserting said cuvette component into a conventional spectrophotometer for placing standard cuvettes to measure the optical density of said specimen and d) measuring the optical density of said specimen.

These and other embodiments, features and advantages of the present invention will become readily apparent upon further review of the following specification and drawings.

### BRIEF DESCRIPTION OF THE DRAWINGS

FIG. 1a shows a schematic view of the capvette wherein the cuvette component is sealably in communication with a screw cap, thereby forming a single device.

FIG. 1b is another schematic view of the capvette with a screw cap with longer height, wherein the cuvette component is sealably in communication with a screw cap, thereby forming a single device.

FIG. 1c shows another view of the capvette embodying the invention. The inside of the cap shows the aperture of the cuvette component and screw threads. In an alternate embodiment, there is provided a filter placed between the aperture and the screw threads to filter out any solids.

FIG. 2a shows the capvette screwed on to a container which is a longitudinal culture tube.

FIG. 2b shows the capvette screwed on to a container which is a culture flask.

FIG. 3a shows the capvette of FIG. 2a being inverted and inserted into a conventional spectrophotometer for taking optical density measurement.

FIG. 3b shows the capvette of FIG. 2b being inverted and inserted into a conventional spectrophotometer for taking optical density measurement.

FIG. 4a shows a plot of the absorbance at 410 nm of Gatorade lemon lime sample as a function of the concentration of Gatorade measured with a conventional cuvette versus a capvette.

FIG. 4b shows a plot of the absorbance at 600 nm of human mouth bacterial culture growth as a function of time taken with a cuvette and a capvette.

Similar reference characters denote corresponding features consistently throughout the attached drawings.

### DETAILED DESCRIPTION OF THE PREFERRED EMBODIMENTS

Optical density is a property of a liquid or suspension that can yield valuable information about the composition of the sample. Optical density is measured using a spectrophotometer. At present, liquids or suspensions of culture containing microorganisms or other materials are handled in a container such as a commercially available 50 mL sterile tube and a 125 ml culture flask. Ordinarily, to measure optical density, a specimen of the liquid or microbial culture (often approximately 1 mL or less) is transferred from the container to a standard optical cuvette using a transfer pipette. Disposable plastic cuvettes are commercially available and routinely used in measuring optical density in a biotech lab. Then the cuvette containing the specimen is inserted into the spectrophotometer and the optical density of the sample is measured. Next, the disposable cuvette and the specimen are discarded. This is almost always the case for microbial cultures. However, expensive and non-disposable quartz cuvettes are also used in certain settings. In this case, the sample is discarded but the cuvette is washed and reused.

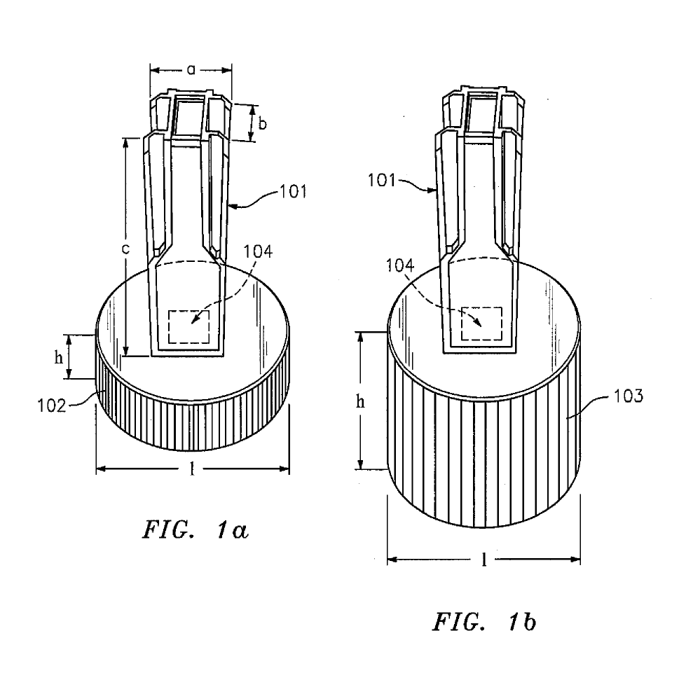

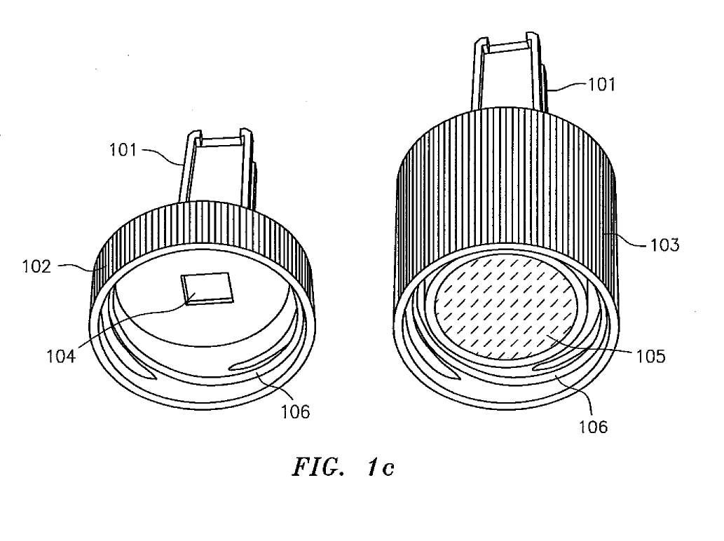

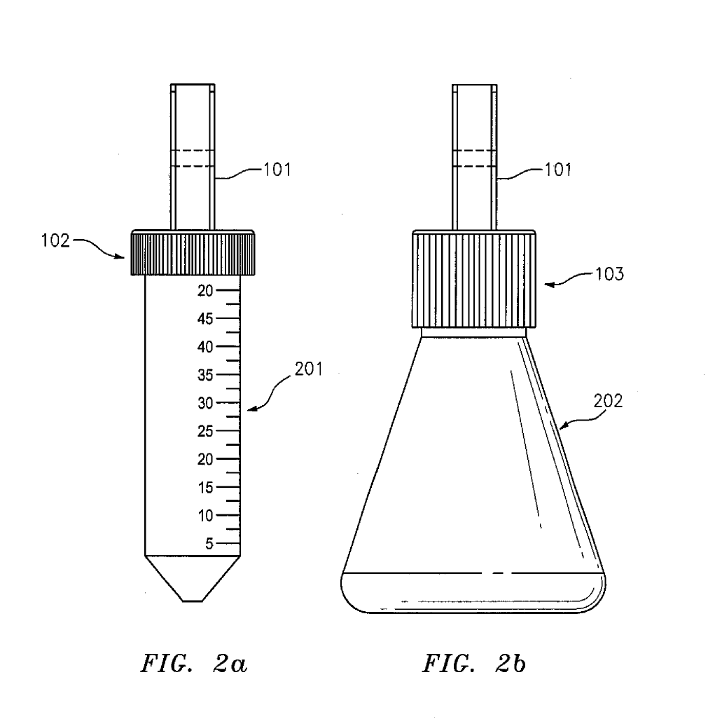

This invention encompasses a device which is a single physical entity that serves the function of both as a closed cap of a container as well as a cuvette for measuring optical density. This device is termed a “Capvette”, which is an optical device containing a standard or routine cuvette component that is sealably in communication with a cap component bearing an aperture at the cap component for passage of fluid between the cuvette component and the container. When said capvette is fitted on to a container vertically above the fluid, and any fluid (liquid or gas) in the container can drain into and out of the cuvette component through said aperture. Two examples of capvettes are shown in FIGS. 1a-1c. In embodiments represented by FIGS. 1a and 1b, the cuvette component 101 is sealable connected to cap components 102 and 103 respectively. The aperture 104 allows for the passage of fluid between the container and the cuvette component when the capvette is fitted tightly to a container. The measurements for capvette are as labeled in FIGS. 1a and 1b are as follows: a=1 cm, b=1 cm, c=2-4 cm, h=1-3 cm, l=1.5-10 cm. FIG. 1c is a side view of the capvettes of FIG. 1a and 1b. In an alternate embodiment, a membrane is attached on to the cap component before the aperture 104 to prevent particles of certain sizes from entering the capvette component. In an embodiment the cap component contains a screw thread 106. In an alternate embodiment a membrane filter is placed between the aperture and the screw thread is in communication. FIGS. 1a and 1b show capvettes with a circular cap that is available for a culture tube and a culture flask. FIG. 1c shows the side view with the aperture 104 at the bottom of the cap component. The cap component comprises plastic with screw threads 106 to be screwed onto a container. However, in alternate embodiment the cap component comprises flexible plastic or rubber without any screw threads. FIGS. 2a and 2b shows the capvette being fitted onto a culture tube 201 or a culture flask 202. This means, disposable (and sterile if necessary) capvette would be manufactured commercially and marketed with the currently used containers or separately as an accessory.

A capvette is then screwed onto the container holding a liquid or a culture broth (at the initiation of culture growth). Two embodiments of said capvette screwed and sealed onto containers are shown in FIGS. 2a (onto a 50 ml tube) and 2b (onto a 125 mL culture flask). The containers with the content are incubated the same way it is done at present. The portion of capvette that screws onto a container looks like a cap, but it has an aperture that opens into the cuvette portion.

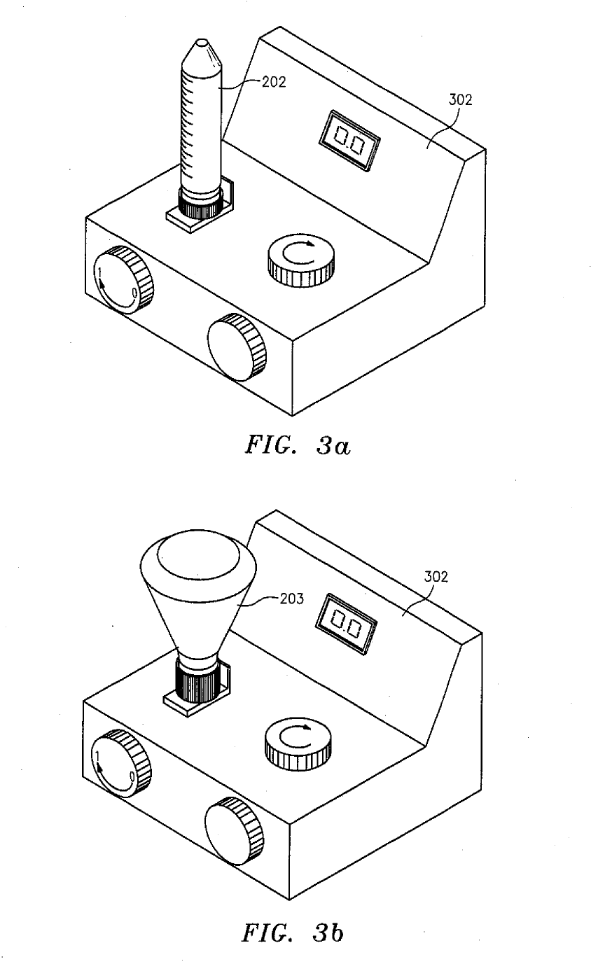

At desired time intervals the container is removed, inverted and the cuvette component of the capvette is inserted into any conventional spectrophotometer 301 as shown in FIGS. 3a and 3b that fits a standard cuvette and the optical density of the liquid or culture is measured. The container, with the capvette is returned to the incubator and the process is repeated as necessary. The cap is sealably connected to the container holding liquid or live organism culture and the device used specifically for holding a specimen of the liquid for taking optical density measurement are combined into one object. In the current state of art the cap and the device used specifically for holding a specimen of the liquid for taking optical density measurements are two separate devices.

In other embodiments if the liquid sample or microbial culture produces gas, then the capvette would enable continuous monitoring the optical density of the gas. The capvette in this instance would have a membrane attached on top of the aperture to prevent liquid from pouring into the cuvette component. Then the capvette would simply be inserted into a spectrophotometer.

### Example 1

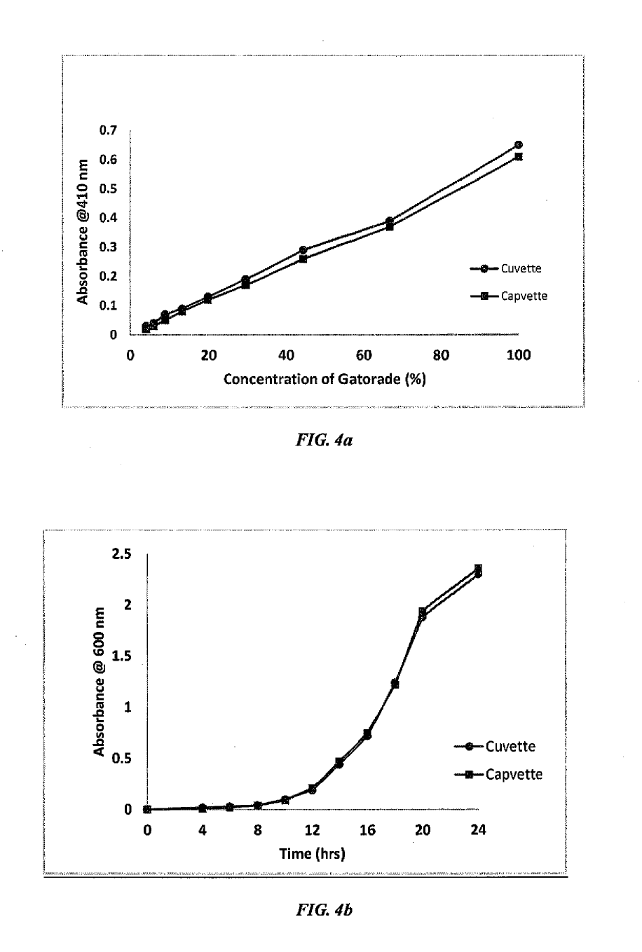

In this example, 9 dilutions of Gatorade Lemon-Lime (Gatorade Co., P.O. Box 049003, Chicago, Ill. 60604) was prepared by serial dilution method. Optical density of each of these dilution samples were measured using the existing art (a conventional cuvette). Subsequently, a capvette of the invention (FIG. 1) was used to record absorbance at 410 nm using a Thermo Scientific Spectronic Educator spectrophotometer at ambient temperature. The measurements and comparison are shown in FIG. 4a. The comparison demonstrates that optical density measurements using Capvette is identical to the existing art although Capvette transforms and provides advantages in rapid sampling and loss of error.

### Example 2

In this example, bacteria from tooth/gum of the inventor was swiped using a sterile cotton swab, inoculated into 50 ml of Luria-Bertani (LB) broth (purchased from Ebay), split into two (one in 50 mL culture tube fitted with traditional cap, and the other in an identical 50 ml culture tube but fitted with Capvette) The bacterial culture was grown at 27-38° C. in the inventor's vehicle parked at his home. His vehicle engine was intermittently turned on to allow vibration of the vehicle to agitate the cultures to facilitate growth of the microorganisms. The inventor then measured optical density of the two parallel cultures using the existing art (a traditional cuvette) and Capvette by recording absorbance at 600 nm using a Thermo Scientific Spectronic Educator spectrophotometer at his home at ambient temperature. The measurements and comparison of the optical density using the capvette and the cuvette are shown in FIG. 4b. The plot demonstrates that optical density measurements using the capvette is identical to the existing art although Capvette transforms and provides advantages in rapid sampling and loss of error as discussed supra.

There are several novel features flowing from this capvette. Foremost, the capvette enables measurement of optical density of liquid or microbe culture without having to transfer a specimen to a detached object without the resulting loss of sample. Therefore, this is a novel from the existing art. Additionally, the capvette prevents random error in optical density measurements since the same capvette is used each time. Use of multiple cuvettes in the existing art naturally leads to random errors associated with non-identical objects. The capvette eliminates multiple steps, shortens and simplifies operating steps in measurement of optical density of liquids and cultures of organism. It significantly reduces the amount of effort, time, and number of cuvettes, transfer pipettes and samples to accomplish the aim. Additionally, the capvette is vertically aligned with the body of the container holding fluid so that the container with reaction mixture or microbial culture can be accommodated in an incubator without the need for additional lateral space. This means a container with a capvette does not need additional lateral space and can be placed into an incubator like a standard container.

Moreover, the capvette eliminates the potential for contamination associated with opening of the liquid or culture of organisms for taking optical density measurements as the culture container does not need to be opened. In the existing art, the container needs to be opened each time an optical density measurement is needed.

Unlike the existing art, a specimen of the liquid or organism culture is never wasted when capvette is used. The capvette reduces waste associated with measurement of optical density of liquids or organism culture. For example, a disposable pipette and or a disposable cuvette are unnecessary for measuring samples using the capvette of the present invention. In addition, the capvette also reduces the need for waste disposal material such as cleaning agent and waste holding bags.

It is to be understood that the present invention is not limited to the embodiments described above, but encompasses any and all embodiments within the scope of the following claims.

I claim:

1. A capvette for the optical examination of liquids comprising:
a cuvette component having a rectangular or square basal surface with four side walls terminating into an aperture, wherein said aperture is in communication with a sealable cap component comprising an opening for fluid passageway from a container into said cuvette component.

2. The capvette of claim 1, wherein the cuvette component is formed of transparent quartz. plastic or glass material.

3. The cuvette of claim 1, wherein the container is selected from the group consisting of a culture flask, a culture test tube, a round bottom flask and a culture bottle.

4. The capvette of claim 1, wherein said cap component comprises screw threads.

5. The capvette of claim 1, wherein said cap is a stretchable cap component without any screw threads.

6. The capvette of claim 5, wherein said stretchable cap component comprises rubber or plastic.

7. The capvette of claim 1, further comprising a filter at the aperture of said cuvette component.

8. A method of measuring optical density of a specimen comprising:
a) inserting the cuvette component of the capvette of claim 1 on to a container containing a specimen whose optical density is to be determined at desired time intervals by fitting said capvette on an opening of said container;
b) inverting said container thereby allowing liquid to flow into the cuvette portion through said hole in the cap component; and
c) inserting said cuvette component into a spectrophotometer:
d) reading the optical density of said specimen.

9. The method of claim 8 further comprising repeating the measurement at desired time intervals.
The capvette of claim 8, wherein the cuvette component is formed of transparent quartz, plastic or glass material.

10. The method of claim 8, wherein the container is selected from the group consisting of a culture flask, a culture test tube and a culture bottle.

11. The method of claim 8, wherein said cap component comprises screw threads.

12. The method of claim 8, wherein said cap is a stretchable cap component without any screw threads.

13. The method of claim 8, wherein said stretchable cap component comprises rubber or plastic.

14. The method of claim 8 further comprising a filter at the opening of said cuvette component.
